(19) United States
(12) Patent Application Publication
(10) Pub. No.: US 2020/0073540 A1
(43) Pub. Date: Mar. 5, 2020

(54) SYSTEMS AND METHODS FOR ENABLING SELECTION OF AVAILABLE CONTENT INCLUDING MULTIPLE NAVIGATION TECHNIQUES

(71) Applicant: OpenTV, Inc., San Francisco, CA (US)

(72) Inventors: Crx CHAI, Oakland, CA (US); Alex FISHMAN, San Francisco, CA (US)

(73) Assignee: OpenTV, Inc., San Francisco, CA (US)

(21) Appl. No.: 16/533,633

(22) Filed: Aug. 6, 2019

Related U.S. Application Data
(63) Continuation of application No. 14/465,043, filed on Aug. 21, 2014, now abandoned.

(51) Int. Cl. G06F 3/0484; G06F 3/0481; H04N 21/431; H04N 21/482; H04N 21/472; H04N 21/81; G06Q 30/02; G06F 3/0482; G06F 16/00

(52) U.S. Cl. CPC G06F 3/04847; G06F 3/0481; G06F 3/04842; H04N 21/4316; H04N 21/4826; H04N 21/4312; H04N 21/4668; H04N 21/47202; H04N 21/431; H04N 21/812; G06Q 30/0241; G06F 3/0482; G06F 16/00; H04N 21/482

(57) ABSTRACT

A device for enabling content selection is configured to display a graphical user interface including a plurality of panes. The plurality of panes may include items of content which are time sensitive and items of content which are not time sensitive. Further, the device may be configured to display other graphical user interfaces include graphical user interfaces that enable menu bar navigation and grid guide navigation.

### CROSS-REFERENCES TO RELATED APPLICATIONS

This application is a continuation of U.S. patent application Ser. No. 14/465,043 filed on Aug. 21, 2014, which is hereby incorporated by reference in its entirety.

### TECHNICAL FIELD

The present disclosure relates to the field of interactive television and graphical user interfaces.

### BACKGROUND

Digital media playback capabilities may be incorporated into a wide range of devices, including digital televisions, including so-called “smart” televisions, laptop or desktop computers, tablet computers, e-book readers, personal digital assistants (PDAs), digital recording devices, digital media players, video gaming devices, digital cameras, cellular or satellite radio telephones, including so-called “smart” phones, dedicated video streaming devices, and the like. Digital media content may originate from a plurality of sources including, for example, over-the-air television providers, satellite television providers, cable television providers, online media-sharing services, including, online media streaming and downloading services, peer devices, and the like. Further, devices with digital media playback capabilities may be configured to output digital media to ultra-resolution displays.

Due to the wide range of content users may access on devices with digital media playback capabilities, traditional techniques for the organizing, sorting, and displaying available content choices may be less than ideal, particularly for televisions and secondary connected devices. Further, traditional electronic programming guides may be intended to be displayed on relatively smaller and/or lower resolution displays than the larger and higher resolution displays that are currently available or may be become available in the future.

### SUMMARY

The following brief summary is not intended to include all features and aspects of the present invention, nor does it imply that the invention must include all features and aspects discussed in this summary. The present disclosure relates to the field of graphical user interfaces and more specifically describes techniques for presenting a user with dynamic interactive graphical user interfaces. In particular, this disclosure describes techniques for enabling content selection. In some examples, the techniques may be implemented in a device with digital media playback capabilities, including for example, laptop or desktop computers, tablet computers, smart phones, set top boxes, and televisions.

According to one example of the disclosure, a method for enabling content selection comprises presenting video content, receiving a user command indicating a desire to search for an item of content, and providing a graphical user interface including a plurality of panes, while continuing to present the video content, wherein the plurality of panes includes at least one pane associated with an available item of content that is time sensitive and at least one pane associated with an available item of content that is not time sensitive.

According to another example of the disclosure, a device for enabling content selection comprises one or more processors configured to present video content, receive a user command indicating a desire to search for an item of content, and provide a graphical user interface including a plurality of panes, while continuing to present the video content, wherein the plurality of panes includes at least one pane associated with an available item of content that is time sensitive and at least one pane associated with an available item of content that is not time sensitive.

According to another example of the disclosure, an apparatus for enabling content selection comprises means for presenting video content, means for receiving a user command indicating a desire to search for an item of content, and means for providing a graphical user interface including a plurality of panes, while continuing to present the video content, wherein the plurality of panes includes at least one pane associated with an available item of content that is time sensitive and at least one pane associated with an available item of content that is not time sensitive.

According to another example of the disclosure, a non-transitory computer-readable storage medium has instructions stored thereon that upon execution cause one or more processors of a device to present video content, receive a user command indicating a desire to search for an item of content, and provide a graphical user interface including a plurality of panes, while continuing to present the video content, wherein the plurality of panes includes at least one pane associated with an available item of content that is time sensitive and at least one pane associated with an available item of content that is not time sensitive.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is block diagram illustrating an example of a system that may implement one or more techniques of this disclosure.

FIG. 2 is a block diagram illustrating an example of a computing device that may implement one or more techniques of this disclosure.

FIG. 3 is a conceptual diagram illustrating an example of an input/output device that may implement one or more techniques of this disclosure.

FIG. 4 is a conceptual diagram illustrating example navigational paths to example graphical user interfaces in accordance with one or more techniques of this disclosure.

FIG. 5A is a conceptual diagram illustrating an example of a graphical user interface in accordance with one or more techniques of this disclosure.

FIG. 5B is a conceptual diagram illustrating an example of a graphical user interface in accordance with one or more techniques of this disclosure.

FIG. 6 is a conceptual diagram illustrating an example of a graphical user interface in accordance with one or more techniques of this disclosure.

FIG. 7A is a conceptual diagram illustrating an example of a graphical user interface in accordance with one or more techniques of this disclosure.

FIG. 7B is a conceptual diagram illustrating an example of a graphical user interface in accordance with one or more techniques of this disclosure.

FIG. 8 is a conceptual diagram illustrating an example of a graphical user interface in accordance with one or more techniques of this disclosure.

FIG. 9 is a conceptual diagram illustrating an example of a graphical user interface in accordance with one or more techniques of this disclosure.

FIG. 10 is a conceptual diagram illustrating an example of a graphical user interface in accordance with one or more techniques of this disclosure.

FIG. 11 is a conceptual diagram illustrating an example of a graphical user interface in accordance with one or more techniques of this disclosure.

FIG. 12 is a conceptual diagram illustrating an example of a graphical user interface in accordance with one or more techniques of this disclosure.

### DETAILED DESCRIPTION

Described herein are systems and methods for enabling the selection of content. Some embodiments extend to a machine-readable medium embodying instructions which, when executed by a machine, cause the machine to perform any one or more of the methodologies described herein. Other features will be apparent from the accompanying drawings and from the detailed description that follows. Examples merely typify possible variations. Unless explicitly stated otherwise, components and functions are optional and may be combined or subdivided, and operations may vary in sequence or may be combined or subdivided. In the following description, for purposes of explanation, numerous specific details are set forth to provide a thorough understanding of example embodiments. It will be evident to one skilled in the art, however, that the present subject matter may be practiced without these specific details.

Devices with digital media playback capabilities, including, for example, televisions, set top boxes, and mobile devices, may be configured to provide users thereof with graphical user interfaces that enable users to select content. In some examples, these graphical user interfaces may be referred to as electronic program guides (EPGs). Traditional electronic program guides may include graphical user interfaces that arrange content in a grid configuration based on a network identifier and timeslots. Due to the increasing amount and types of available content, selection using a traditional grid guide for content navigation may be cumbersome. For example, a television service provider may provide subscribers with hundreds of potential channels and thousands of items of content available on an “on demand” basis. A user may need to scroll/sort through hundreds of items of content in order to find desired content. Further, there are multiple ways for a user to access content other than the traditional method of tuning to a particular channel at a particular time. For example, a television show may be accessed by a user on an “on demand” basis from one of a plurality of sources.

Content is increasing available through a group (also referred to as a “family”) of networks. For example, a sporting event may be available through one of a plurality of the ESPN networks or the ABC network. In some cases, a group of networks does not correspond to a sequential listing of channels and may span a range of hundreds of channels. In the case where a sporting event is provided through a family of networks, a user may know the sporting event that he or she wishes to view and the time at which the event will begin, but the user may not know which network within the television listings and/or which network within a family of networks will provide the particular sporting event. Trying to find the sporting event or another live event by navigating a traditional grid guide may be unnecessarily time consuming and frustrating to a user, as it may require scrolling through multiple pages of television listings while the event is occurring.

The techniques described herein enable a user to browse and find content using multiple types of graphical user interfaces. The example graphical user interfaces display different amounts and types of available content and provide varying levels of interference with content a user is currently viewing. The techniques described herein seek to enable a user to navigate to content that a user most likely desires to access as efficiently as possible, i.e., minimize the time and number of user commands required to navigate to a particular item of content. The example techniques described herein may be used to provide graphical user interfaces featuring content a user likely desires based on predictive techniques and where a user is unable to find desired content using a particular graphical user interface, provide other types of graphical user interfaces which may enable the user to find desired content. Further, the graphical user interfaces described herein may enable a user to navigate to time sensitive content (e.g., live events and currently airing new content) in an efficient manner. Further, the graphical user interfaces described herein may be utilized by a service provider to increase revenue opportunities. For example, graphical user interfaces described herein may efficiently allow a user to select desired content while providing advertisements and/or featuring premium content.

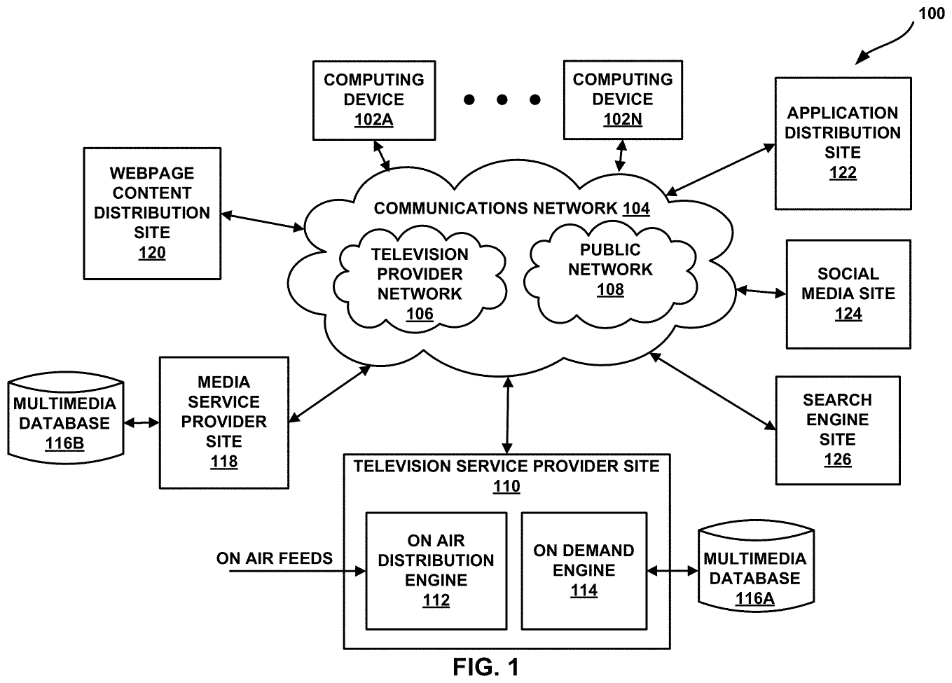

FIG. 1 is block diagram illustrating an example of a system that may implement one or more techniques described in this disclosure. System 100 may be configured to enable content selection in accordance with the techniques described herein. In the example illustrated in FIG. 1, system 100 includes one or more computing devices 102A-102N, communications network 104, television service provider site 110, media service provider site 118, webpage content distribution site 120, application distribution site 122, social media site 124, and search engine site 126. System 100 may include software modules operating on one or more servers. Software modules may be stored in a memory and executed by a processor. Servers may include one or more processors and a plurality of internal and/or external memory devices. Examples of memory devices include file servers, FTP servers, network attached storage (NAS) devices, local disk drives, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow digital content, such as, for example, music, videos, images, webpages, messages, voice communications, and applications, to be distributed to and accessed by a plurality of computing devices, such as computing devices 102A-102N. In the example illustrated in FIG. 1, computing devices 102A-102N may include any device configured to transmit data to and/or receive data from communication network 104. For example, computing devices 102A-102N may be equipped for wired and/or wireless communications and may include set top boxes, digital video recorders, televisions, desktop, laptop, or tablet computers, gaming consoles, mobile devices, including, for example, “smart” phones, cellular telephones, and personal gaming devices. It should be noted that although example system 100 is illustrated as having distinct sites, such an illustration is for descriptive purposes and does not limit system 100 to a particular physical architecture. Functions of system 100 and sites included therein may be realized using any combination of hardware, firmware and/or software implementations.

Communications network 104 may comprise any combination of wireless and/or wired communication media. Communications network 104 may include coaxial cables, fiber optic cables, twisted pair cables, wireless transmitters and receivers, routers, switches, repeaters, base stations, or any other equipment that may be useful to facilitate communications between various devices and sites. Communications network 104 may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the 802 standards.

As illustrated in FIG. 1, networks of different types may be defined within communications network 104. Networks may be defined according to physical and/or logical aspects. For example, networks that share the same physical infrastructure (e.g., coaxial cables) may be distinguished based on a primary service type (e.g., webpage access or television service). Physical and logical aspects of networks may be described according to a layered model. For example, layers of a model may respectively define physical signaling, addressing, channel access control, packet properties, and data processing in a communications system. One example of a layered model is the Open Systems Interconnection (OSI) model. In the example illustrated in FIG. 1, communications network 104 includes television provider network 106 and public network 108. It should be noted that although television provider network 106 and public network 108 are illustrated as distinct, television provider network 106 and public network 108 may share physical and/or logical aspects.

Television provider network 106 is an example of a network configured to provide a user with television services. For example, television provider network 106 may include public over-the-air television networks, public or subscription-based satellite television service provider networks, and public or subscription-based cable television provider networks. It should be noted that although in some examples television provider network 106 may primarily be used to provide television services, television provider network 106 may also provide other types of data and services according to any combination of the telecommunication protocols described herein.

Public network 108 is an example of a packet-based network, such as, a local area network, a wide-area network, or a global network, such as the Internet, configured to provide a user with World Wide Web based services. Public network 108 may be configured to operate according to Internet Protocol (IP) standards. It should be noted that although in some examples public network 108 may primarily be used to provide access to hypertext web pages, public network 108 may also provide other types of media content according to any combination of the telecommunication protocol described herein.

Referring again to FIG. 1, television service provider 110 represents an example of a television service provider site. Television service provider 110 may be configured to provide computing devices 102A-102N with television service. For example, television service provider 110 may be a public broadcast station, a cable television provider, or a satellite television provider and may be configured to provide television services to analog and/or digital televisions and set top boxes. In the example illustrated in FIG. 1, television service provider 110 includes on air distribution engine 112 and on demand engine 114. On air distribution engine 112 may be configured to receive a plurality of on air feeds and distribute the feeds to computing devices 102A-102N through television provider network 106. For example, on air distribution engine 112 may be configured to receive one or more over-the-air television broadcasts via a satellite uplink/downlink and distribute the over-the-air television broadcasts to one or more users of a subscription-based cable television service.

On demand engine 114 may be configured to access a multimedia library and distribute multimedia content to one or more of computing devices 102A-102N through television provider network 106. For example, on demand engine 114 may access multimedia content (e.g., music, movies, and TV shows) stored in multimedia database 116A and provide a subscriber of a cable television service with movies on a Pay Per View (PPV) basis. Multimedia database 116A may be a storage device configured to store multimedia content. It should be noted that multimedia content accessed through on demand engine 114 may also be located at various sites within system 100 (e.g., peer-to-peer distribution).

Media service provider site 118 represents an example of a multimedia service provider. Media service provider site 118 may be configured to access a multimedia library and distribute multimedia content to one or more of computing devices 102A-102N through public network 108. For example, media service provider site 118 may access multimedia (e.g., music, movies, and TV shows) stored in multimedia database 116B and provide a user of a media service with multimedia. In some examples, multimedia may include live events (e.g., sporting events) and/or currently airing television programs. Multimedia database 116B may be a storage device configured to store multimedia content. In one example, media service provider site 118 may be configured to provide content to one or more of computing devices 102A-102N using the Internet protocol suite. In some examples, a media service may be referred to as a streaming service. Commercial examples of media services may include Hulu, YouTube, Netflix, Amazon Prime, and television network based streaming services (e.g. WatchESPN). As described above, television provider network 106 and public network 108 may share physical and logical aspects. Thus, content accessed by one or more of computing devices 102A-102N through media service provider site 118 may be transmitted through physical components of television provider network 106. For example, a user of a computing device may access the internet and multimedia content provided by a media service may be provided to a user through a cable modem connected to a coaxial network maintained by a cable television provider.

Webpage content distribution site 120 represents an example of a webpage service provider. Webpage content distribution site 120 may be configured to provide hypertext based content to one or more of computing devices 102A-102N through public network 108. It should be noted that hypertext based content may include audio and video content. Hypertext content may be defined according to programming languages, such as, for example, Hypertext Markup Language (HTML), Dynamic HTML, and Extensible Markup Language (XML). Examples of webpage content distribution sites include the Wikipedia website and the United States Patent and Trademark Office website.

Application distribution site 122 represents an example of an application distribution service. Application distribution site 122 may be configured to distribute developed software applications to one or more of computing devices 102A-102N. In one example, software applications may include games and programs operable on computing devices. In other examples, software applications may be configured to allow a computing device to access content provided by a site in manner specific to the computing device. For example, software applications may be configured to provide enhanced or reduced functionality of a webpage to a mobile device or a set top box. Software applications may be developed using a specified programming language. Examples of programming languages include, ActionScript, Java™, Jini™, C, C++, Perl, Python, UNIX Shell, Visual Basic, and Visual Basic Script. In some examples, developers may write software applications using a software development kit (SDK) provided by a device manufacturer or a service provider. In the example where one or more of computing devices 102A-102N are mobile devices, application distribution site 122 may be maintained by a mobile device manufacturer, a service provider, and/or a mobile device operating system provider. In the example where one or more of computing devices 102A-102N are set top boxes, application distribution site 108 may be maintained by a set top box manufacturer, a service provider, and/or an operating system provider. In some examples, an application distribution site may be referred to as an app store. Examples of commercially available application distribution sites include Google Play, the Apple App Store, BlackBerry World, Windows Phone Store, and the Amazon Appstore.

Social media site 124 represents an example of a social media service. Social media site 124 may be configured to allow users of computing devices 102A-102N to communicate with one another. Social media site 124 may be configured to host profile pages corresponding to users of computing devices 102A-102N. For example, social media site 124 may be configured such that users of computing devices 102A-102N are able to display messages and upload photos, videos, and other media to a user's profile page. Examples of commercially available social media sites include Facebook, YouTube, Linkedin, Google Plus, Twitter, Flickr, and Instagram. In addition to allowing users to maintain profile pages, social media site 124 may be configured to generate analytical data based on information included in user profile pages and/or user activity. For example, social media site 124 may be configured to track the popularity of a news story based on comments provided by users of computing devices 102A-102N. As described in detail below, the techniques described may incorporate data from social media sites to determine the popularity of content and to present content to a user based on recommendations from other users.

Search engine site 126 represents an example of a content search service. Search engine site 126 may be a service configured to allow users of computing devices 102A-102N to search for content available through communications network 104. Search engine site 126 may be configured to receive queries from computing devices 102A-102N and provide a list of search results to computing devices 102A-102N. For example, search engine site 126 may be configured such that users of computing devices 102A-102N are presented with a webpage including a search query field and are able to search content based on keywords. Examples of commercially available search engine sites include Google, Bing, and Yahoo! Further, search engine site 126 may be configured to generate analytical data based on information included in search queries. For example, search engine site 126 may be configured to track the popularity of an actress based on the number of times a query related to the actress is provided by users of computing devices 102A-102N.

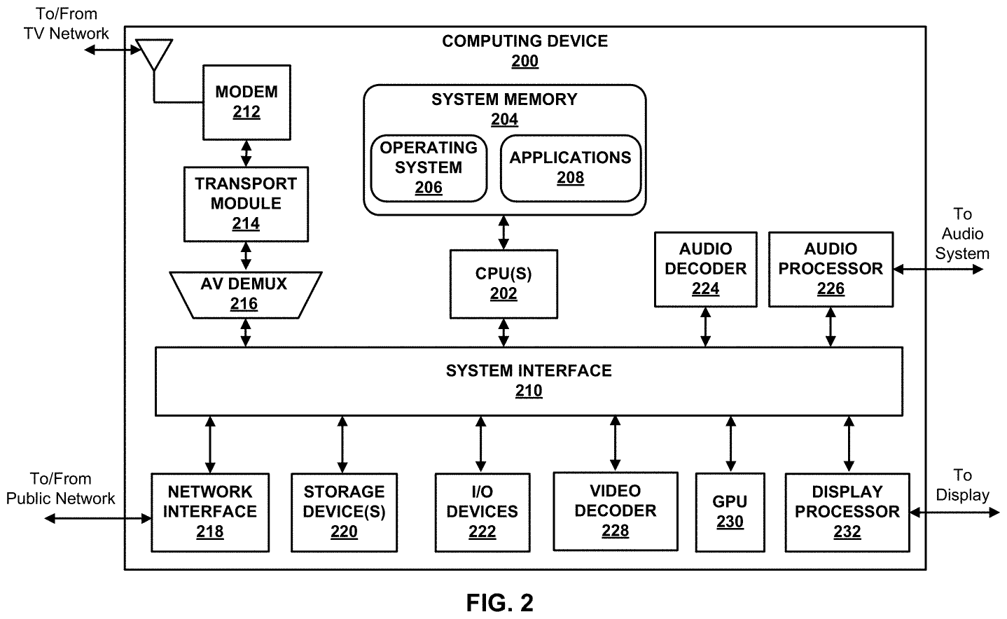

FIG. 2 is a block diagram illustrating an example of a computing device that may implement one or more techniques of this disclosure. Computing device 200 is an example of a computing device that may be configured to transmit data to and receive data from a communications network, allow a user to access multimedia content, and execute one or more applications. Computing device 200 may include or be part of a stationary computing device (e.g., a desktop computer, a television, a set-top box, a gaming console, a dedicated multimedia streaming device, or a digital video recorder), a portable computing device (e.g., a mobile phone, a laptop, a personal data assistant (PDA), or a tablet device) or another type of computing device. In the example illustrated in FIG. 2, computing device 200 is configured to send and receive data via a television network, such as, for example, television network 106 described above and send and receive data via a public network, such as, for example, public network 108. It should be noted that in other examples, computing device 200 may be configured to send and receive data through one of a television network 106 or a public network 108. The techniques described herein may be utilized by devices configured to communicate using any and all combinations of communications networks.

As illustrated in FIG. 2, computing device 200 includes central processing unit(s) 202, system memory 204, system interface 210, modem 212, transport module 214, AV demux 216, network interface 218, storage devices 220, I/O devices 222, audio decoder 224, audio processor 226, video decoder 228, graphics processing unit 230, and display processor 232. As illustrated in FIG. 2, system memory 106 includes operating system 206 and applications 208. Each of processor(s) 202, system memory 204, system interface 210, modem 212, transport module 214, AV demux 216, network interface 218, storage devices 220, I/O devices 222, audio decoder 224, audio processor 226, video decoder 228, graphics processing unit 230, and display processor 232 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

CPU(s) 202 may be configured to implement functionality and/or process instructions for execution in computing device 200. CPU(s) 202 may be capable of retrieving and processing instructions, code, and/or data structures for implementing one or more of the techniques described herein. Instructions may be stored on a computer readable medium, such as system memory 204 or storage devices 220. CPU(s) 202 may include multi-core central processing units.

System memory 204 may be described as a non-transitory or tangible computer-readable storage medium. In some examples, system memory 204 may provide temporary and/or long-term storage. In some examples, system memory 204 or portions thereof may be described as non-volatile memory and in other examples portions of system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories.

System memory 204, may be configured to store information that may be used by computing device 200 during operation. System memory 204 may be used to store program instructions for execution by CPU(s) 202 and may be used by software or applications running on computing device 200 to temporarily store information during program execution. For example, system memory 204 may store instructions associated with operating system 206 and applications 208. Applications 208 may include applications implemented within or executed by computing device 200 and may be implemented or contained within, operable by, executed by, and/or be operatively/communicatively coupled to components of computing device 200. Applications 208 may include instructions that may cause CPU(s) 202 of computing device 200 to perform particular functions. Applications 208 may include algorithms which are expressed in computer programming statements, such as, for-loops, while-loops, if-statements, do-loops, etc. Applications 208 may be distributed to computing device 200 through an application distribution site, such as, for example, application distribution site 122 described above.

As further illustrated in FIG. 2, applications 208 may execute in conjunction with operating system 206. That is, operating system 206 may be configured to facilitate the interaction of applications 208 with CPUs(s) 202, and other hardware components of computing device 200. It should be noted that in some examples, components of operating system 206 and components acting in conjunction with operating system 206 may be referred to as middleware. The techniques described herein may be utilized by devices configured to operate using any and all combinations of software architectures. Operating system 206 may be an operating system designed to be installed on laptops, desktops, smartphones, tablets, set-top boxes, digital video recorders, televisions and/or gaming devices. In one example, operating system 206 may include one or more of operating systems or middleware components developed by OpenTV, Windows operating systems, Linux operation systems, Mac operating systems, Android operating systems, and any and all combinations thereof.

System interface 210, may be configured to enable communications between components of computing device 200. In one example, system interface 210 comprises structures that enable data to be transferred from one peer device to another peer device or to a storage medium. For example, system interface 210 may include a chipset supporting Accelerated Graphics Port (“AGP”) based protocols, Peripheral Component Interconnect (PCI) bus based protocols, such as, for example, the PCI Express™ (“PCIe”) bus specification, which is maintained by the Peripheral Component Interconnect Special Interest Group, or any other form of structure that may be used to interconnect peer devices.

Storage devices 220 represent memory of computing device 200 that may be configured to store relatively larger amounts of information for relatively longer periods of time than system memory 204. For example, in the example where computing device 200 is included as part of a digital video recorder, storage devices 220 may be configured to store numerous video files. Similar to system memory 204, storage device(s) 220 may also include one or more non-transitory or tangible computer-readable storage media. Storage device(s) 220 may include internal and/or external memory devices and in some examples may include volatile and non-volatile storage elements. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media.

I/O devices 222 may be configured to receive input and provide output during operation of computing device 200. Input may be generated from an input device, such as, for example, a push-button remote control, a motion based remote control, a device including a touch-sensitive screen, a device including a track pad, a mouse, a keyboard, a microphone, a video camera, a motion sensor, or any other type of device configured to receive user input. In one example, an input device may include an advanced user input device, such as a smart phone or a tablet computing device. For example, an input device may be a secondary computing device and may be configured to receive user input via touch gestures, buttons on the secondary computing device, and/or voice control. Further, in some examples, an input device may include a display that is configured to display the graphical users interfaces described herein. For example, in the case where computing device 200 includes a television, an input device may include a smart phone in communication with the television. In this example, a user may provide commands to a television by activating portions of a graphical user interface displayed on a smart phone. Output may be provided to output devices, such as, for example internal speakers, an integrated display device, and/or external components, such as, a secondary computing device. In some examples, I/O device(s) 222 may be operatively coupled to computing device 200 using a standardized communication protocol, such as for example, Universal Serial Bus protocol (USB), Bluetooth, ZigBee or a proprietary communications protocol, such as, for example, a proprietary infrared communications protocol.

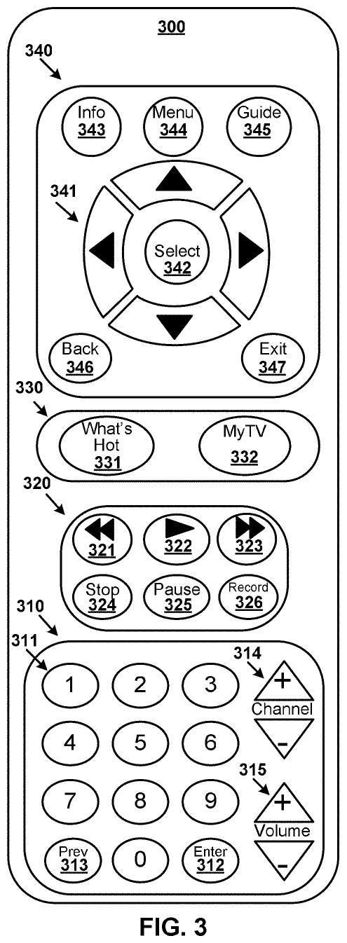

FIG. 3 is a conceptual diagram illustrating an example of an input/output device that may implement one or more techniques of this disclosure. In the example illustrated in FIG. 3, I/O device 300 is illustrated as a push-button remote control. It should be noted that while I/O device 300 is illustrated as a push-button remote control in the example illustrated in FIG. 3, in other examples the functionality of I/O device 300 may be implemented using other I/O devices, such as, for example, a secondary computing device in communication with a primary computing device. Further, in other examples, functions achieved by activation of buttons of I/O device 300 may be achieved through other types of user inputs. For example, in the case where an I/O device includes a touchscreen, gesture recognition, and/or voice recognition, virtual buttons may be presented on the touchscreen and functions achieved by activation of buttons on I/O device 300 may be achieved through any and all combinations of virtual button activation, motion gestures, and/or voice commands. In one example, an I/O device may have voice recognition capabilities and a function achieved by activation of MyTV button 332 may be achieved by a user saying “My TV” or a similar phrase.

In the example illustrated in FIG. 3, I/O device 300 includes basic television controls 310, playback controls 320, direct graphical user interface controls 330, and navigational controls 340. Basic television controls 310 may be configured to enable a user to perform basic tuning and volume control functions associated with viewing television programming. As illustrated in FIG. 3, basic television controls 310 include numeric keypad 311, enter button 312, previous channel button 313, channel change buttons 314, and volume control buttons 315. Numeric keypad 311, enter button 312, previous channel button 313, and channel buttons 314 may be configured to enable a user to tune to a particular analog and/or digital channel. Upon a user entering a sequence of numbers using numeric keypad 311 and, optionally, additionally activating enter key 312, a tuner may tune to a specified channel. Upon activation of previous channel button 313, a tuner may tune to a previously tuned channel. Activation of “+” and “−” channel buttons 314 may respectively cause a tuner to tune to the respective next channel in a sequence of channels. Activation of “+” and “−” volume control buttons 315 may respectively cause the output of an audio system to be increased or decreased. It should be noted that although the basic television controls 310 may be configured to enable a user to perform basic tuning and volume control functions associated with a television, in some examples, basic television controls 312 may be used to perform other functions associated with a computing device. For example, in the case where graphical user interface 500, described below, is presented to a user, activation of “+” and “−” channel buttons 314 may cause items included in a category of content associated with a selected pane to be cycled through.

Playback controls 320 may be configured to enable a user to control the playback of and/or record multimedia content. For example, playback controls 320 may enable a user to control the playback of a video originating from a media service provider site, an on demand engine, and/or a personal video recorder (PVR). As illustrated in FIG. 3, playback controls 320 include reverse playback button 321, normal playback button 322, forward playback button 323, stop playback button 324, pause playback button 325, and record button 326. Reverse playback button 321 may enable a user to navigate to a previous point in a multimedia sequence. Upon activation, normal playback button 322 may cause normal playback of an item of multimedia content to begin or resume. Forward playback button 323 may enable a user to navigate to a future point in a multimedia sequence. Upon activation, stop playback button 324 may cause the playback of an item of multimedia content to cease. Upon activation, pause playback button 325 may cause the playback of an item of multimedia content to be paused. Record button 326 may enable a user to cause an item of multimedia content to be stored to a storage device. It should be noted that although playback controls 320 may be configured to enable a user to control the playback of and/or record multimedia content, in some examples playback controls 320 may be used to perform other functions associated with a computing device. For example, in the case where a graphical user interface is presented to a user, activation of record button 326 may cause a graphical user interface for scheduling recordings to be displayed.

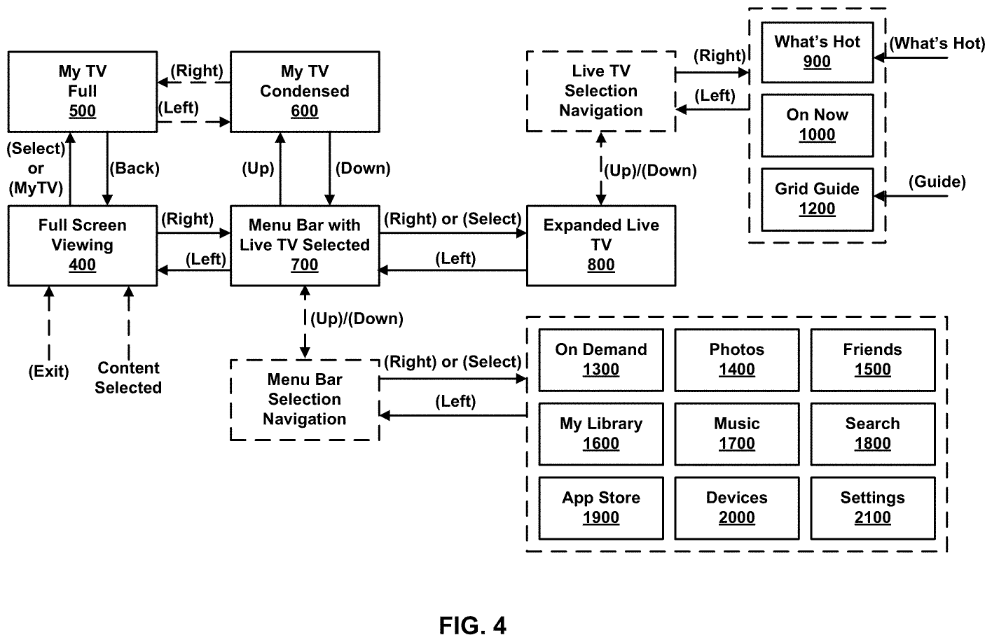

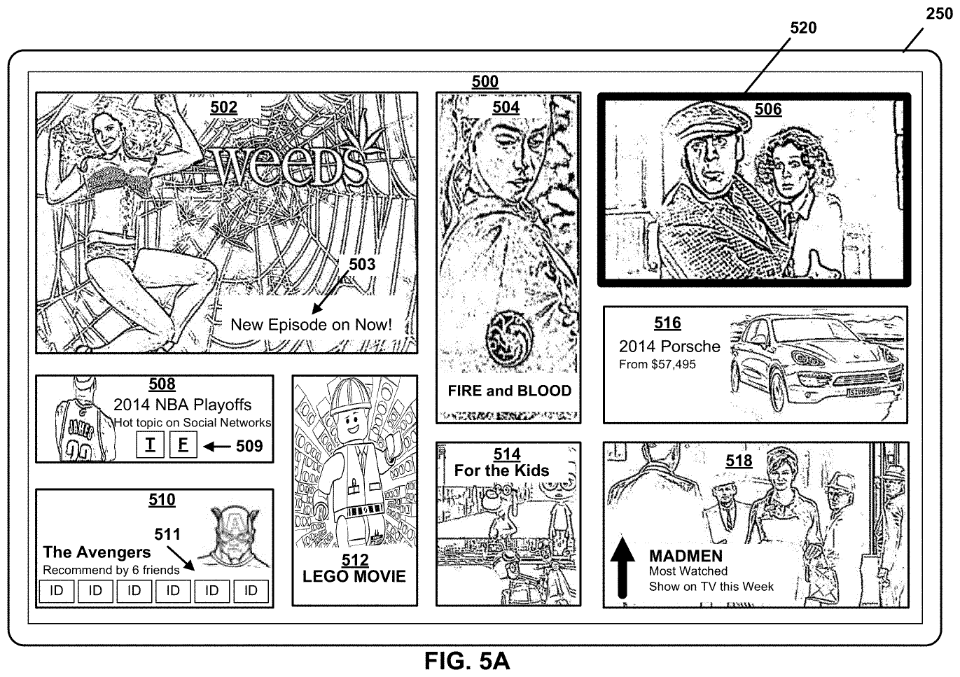

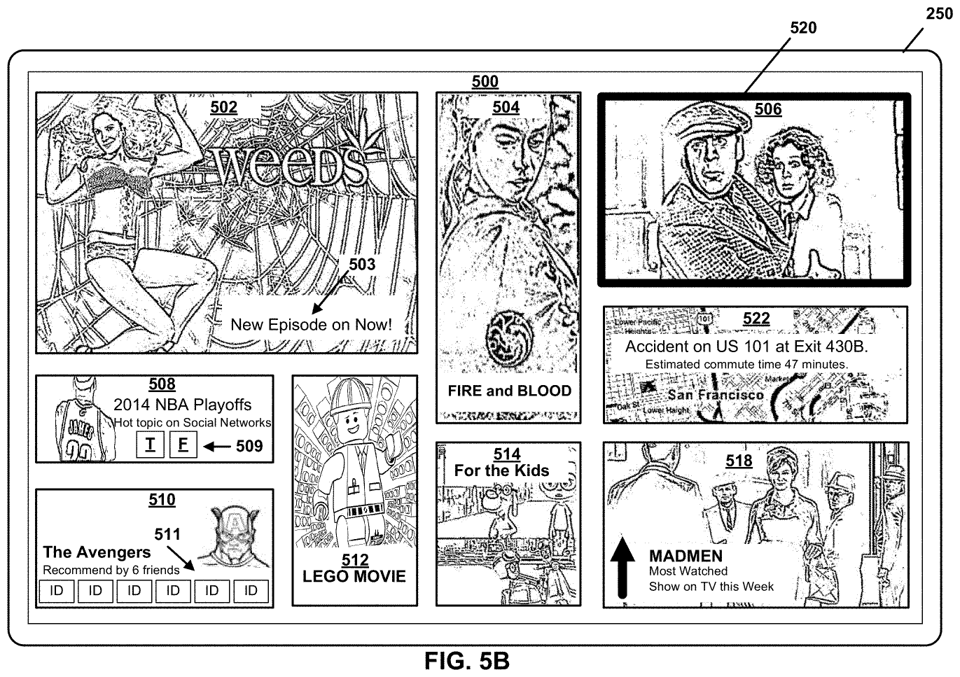

As described above, devices with digital media playback capabilities, including, for example, televisions, set top boxes, and mobile devices, may be configured to provide users thereof with graphical user interfaces that enable the selection of content. Navigational controls 340 may be configured to enable a user to navigate graphical user interfaces and select content using a graphical user interface. In one example, navigational controls 340 may be configured to enable a user to navigate graphical user interfaces and select content using one of more of the example graphical user interfaces described below with respect to FIGS. 5A-12. Further, as described below with respect to FIG. 4, navigational controls 340 may be configured to enable a user to cause different ones of the example graphical user interfaces described herein to be presented. For example, activation of the select button 342 during the presentation of content in a full screen viewing mode may cause graphical user interface 500 to be presented and activation of the right arrow button during the presentation of content in a full screen viewing mode may cause graphical user interface 700 to be presented.

In the example illustrated in FIG. 3, navigational controls 340 include navigational arrow buttons 341, select button 342, information button 343, menu button 344, guide button 345, back button 346, and exit button 347. Navigational arrow buttons 341 may be configured to move the position of a cursor associated with a graphical user interface and/or change the selection of an item included in a graphical user interface. For example, navigational arrow buttons 341 may enable the user to change the selection of a pane in a graphical user interface as described below with respect to FIG. 5A.

Select button 342 may enable a user to further select an item of content. As described in detail below, an icon or pane representing an item of content may be associated with multiple levels and types of selection. In one example, activation of select button 342 may cause an additional level of selection to occur. Information button 343 may be configured to cause additional information associated with an item of content to be displayed. For example, when an icon representing an item of content is initially selected, activation of information button 343 may cause information associated with the content (e.g., cast and crew information) to be displayed.

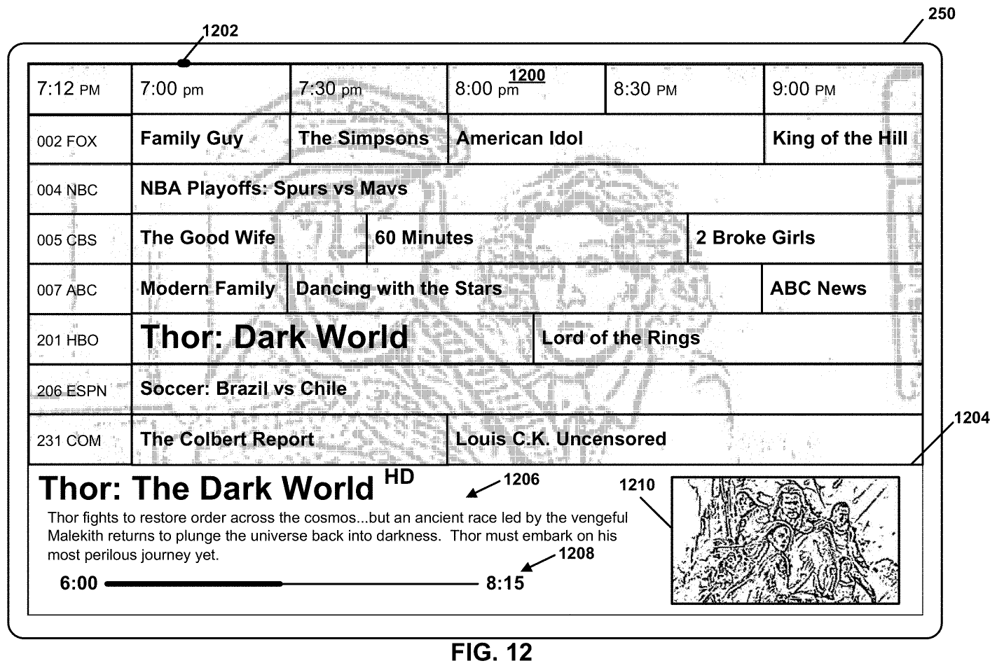

Menu button 344, guide button 345, back button 346, and exit button 347 may be configured to enable a user to cause different graphical user interfaces to be presented. Upon activation, menu button 344 may cause a graphical user interface including a high level menu to be displayed. In one example, a high level menu may include a menu that enables a user to change settings associated with the operation of a computing device. Upon activation, guide button 345 may be configured to provide a graphical user interface that enables a user to select content. In one example, upon activation of guide button 345, graphical user interface 1200 described with respect to FIG. 12 below may be presented to a user. Back button 346 may be configured to enable a user to return to a previously displayed graphical user interface. Exit button 347 may be configured to enable a user to return to a full screen viewing mode.

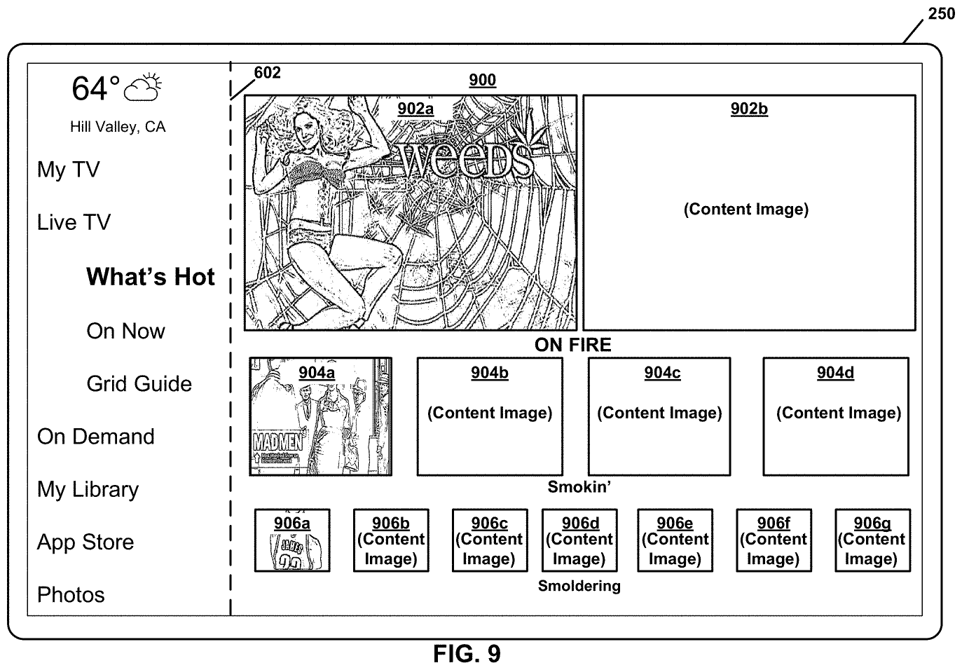

Direct graphical user interface controls 330 may be configured to enable a user to display a particular graphical user interface. In the example illustrated in FIG. 3, direct graphical user interface controls 330 include What's Hot button 331 and MyTV button 332. Upon activation, each of What's Hot button 331 and MyTV button 332 may be configured to provide respective graphical user interfaces that enable a user to select content. In one example, upon activation of What's Hot button 331, graphical user interface 900 described with respect to FIG. 9 below may be presented to a user. In one example, upon activation of MyTV button 332, graphical user interface 500 described with respect to FIG. 5A below may be presented to a user. Each of graphical user interface 500, graphical user interface 900, and graphical user interface 1200 represent different types of graphical user interfaces that enable a user to select particular items content. In the example scenario of a user desiring to view a sporting event described above, each of graphical user interface 500, graphical user interface 900, and graphical user interface 1200 may enable a user to find and select the sporting event using different navigational techniques. In this manner, I/O device 300 may be configured to enable a user to select an item of content using multiple navigational techniques.

Referring again to FIG. 2, computing device 200 is configured to send and receive data via a television network, such as, for example, television network 106 described above and send and receive data via a public network, such as, for example, public network 108. As described above, a communications network may be described based on a model including layers that define communication properties, such as, for example, physical signaling, addressing, channel access control, packet properties, and data processing in a communications system. In the example illustrated in FIG. 2A, modem 212, transport module 214, and AV demux 216 may be configured to perform lower layer processing associated with television network 106 and network interface 218 may be configured to perform lower layer processing associated with public network 108.

In one example, modem 212 may be configured to perform physical signaling, addressing, and channel access control according to the physical and MAC layers utilized in a television provider network, such as, for example, television provider network 106. In one example, modem 212 may configured to receive signals from a coaxial cable and/or an over the air signal and perform low level signal processing (e.g., demodulation). In one example, modem 212 may be configured to extract transport streams from signals received from a coaxial cable. In one example, a transport stream may be based on a transport stream defined by the Moving Pictures Experts Group (MPEG). In one example, a transport stream may include a plurality of program streams where each program stream respectively corresponds to a program available from a television network. Further, a transport stream may include a plurality of data streams (e.g., Program Map Table and EPG data).

Transport module 214 may be configured to receive data from modem 212 and process received data. For example, transport model 214 may be configured to receive a transport stream including a plurality of program streams and extract individual program streams from a received transport stream. In one example, a program stream may include a video stream, an audio stream, and a data stream. AV demux 216 may be configured to receive data from transport module 214 and process received data. For example, AV demux 216 may be configured to receive a program stream from transport module 214 and extract audio packets, video packets, and data packets. That is, AV demux 216 may apply demultiplexing techniques to separate video streams, audio streams, and data streams from a program stream. In one example, AV demux 216 may be configured to decapsulate packetized elementary video and audio streams from a transport stream defined according to MPEG-2 Part 1. It should be noted that although modem 212, transport module 214, and AV demux 216 are illustrated as having distinct functional blocks, the functions performed by modem 212, transport module 214, and AV demux 216 may be highly integrated and realized using any combination of hardware, firmware and/or software implementations.

Network interface 218 may be configured to enable computing device 200 to send and receive data via a public network. As described above, data sent or received via a public network may include data associated digital content, such as, for example, music, videos, images, webpages, messages, voice communications, and applications. Network interface 218 may include a network interface card, such as an Ethernet card, an optical transceiver, a radio frequency transceiver, or any other type of device configured to send and receive information. Network interface 218 may be configured to perform physical signaling, addressing, and channel access control according to the physical and MAC layers utilized in a public network, such as for example, public network 108. Further, in a manner similar to that described above with respect to transport module 214 and A/V demux 216, network interface 218 may be configured to extract audio packets, video packets, and data packets from a data stream. For example, network interface 218 may be configured to extract video packets, audio packets, and data packets according to one or more of internet protocol (IP), transport control protocol (TCP), real time streaming protocol (RTSP), user datagram protocol (UDP), real time protocol (RTP), MPEG transport stream protocols, and IPTV protocols. It should be noted, that the techniques described herein are generally applicable to any and all methods of digital content distribution and are not limited to particular communications network implementations. For example, the techniques described herein may be applicable to digital content originating from one or more of a broadcast, a multicast, a unicast, an over-the-top content source, a personal video recorder (PVR), and a peer-to-peer content source.

Referring again to FIG. 2, data associated with digital content, such as, for example, music, videos, images, webpages, messages, voice communications, and applications may be stored in a computer readable medium, such as, for example, system memory 204 and storage devices 220. Data stored in a memory device may be retrieved and processed by CPU(s) 202, audio decoder 224, audio processor 226, video decoder 228, graphics processing unit 230, and display processor 232. As described above, CPU(s) 202 may be capable of retrieving and processing instructions, code, and/or data structures for implementing one or more of the techniques described herein. Each of audio decoder 224, audio processor 226, video decoder 228, graphics processing unit 230, and display processor 232 may also be capable of retrieving and processing instructions, code, and/or data structures for implementing one or more of the techniques described herein.

Audio decoder 224 may be configured to retrieve and process coded audio data. For example, audio decoder 224 may be a combination of hardware and software used to implement aspects of audio codec. Audio data may be coded using multi-channel formats such as those developed by Dolby and Digital Theater Systems. Audio data may be coded using a compressed or uncompressed format. Examples of compressed audio formats include MPEG-1, 2 Audio Layers II and III, AC-3, AAC, and Ogg Vorbis. An example of an uncompressed audio format includes pulse-code modulation (PCM) audio format. Audio processor 226 may be configured to retrieve captured audio samples and may process audio data for output to an audio system (not shown). In some examples, audio processor 226 may include a digital to analog converter. An audio system may comprise any of a variety of audio output devices such as headphones, a single-speaker system, a multi-speaker system, or a surround sound system.

Video decoder 228 may be configured to retrieve and process coded video data. For example, video decoder 228 may be a combination of hardware and software used to implement aspects of video codec. In one example, video decoder 228 may be configured to decode video data encode according to any number of video compression standards, such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8, and High-Efficiency Video Coding (HEVC).

As described above, a device with media playback capabilities may provide a graphical user interface that enables a user to select content. A graphical user interface may include images and graphics displayed in conjunction with video content (e.g., playback icons overlaid on a video). Graphics processing unit 230 is an example of a dedicated processing unit that may be configured to generate graphical user interfaces, including the graphical user interfaces described herein. That is, graphics processing unit 230 may be configured to receive commands and content data and output pixel data. Graphic processing unit 230 may operate according to a graphics pipeline process (e.g., input assembler, vertex shader, geometry shader, rasterizer, pixel shader, and output merger). Graphics processing unit 230 may include multiple processing cores and may be configured to operate according to OpenGL (Open Graphic Library, managed by the Khronos Group) and/or Direct3D (managed by Microsoft, Inc.).

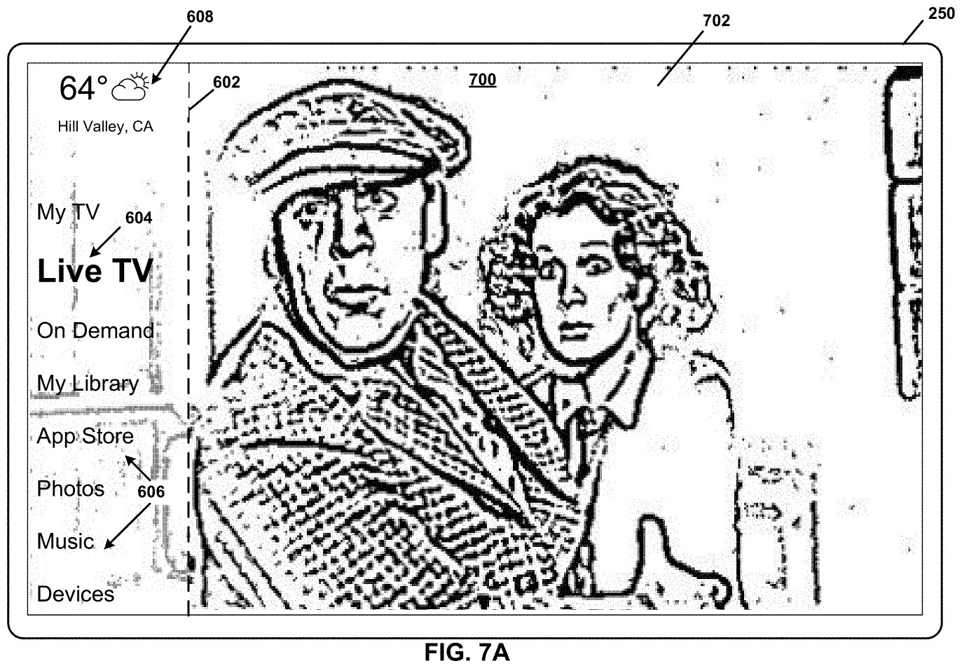

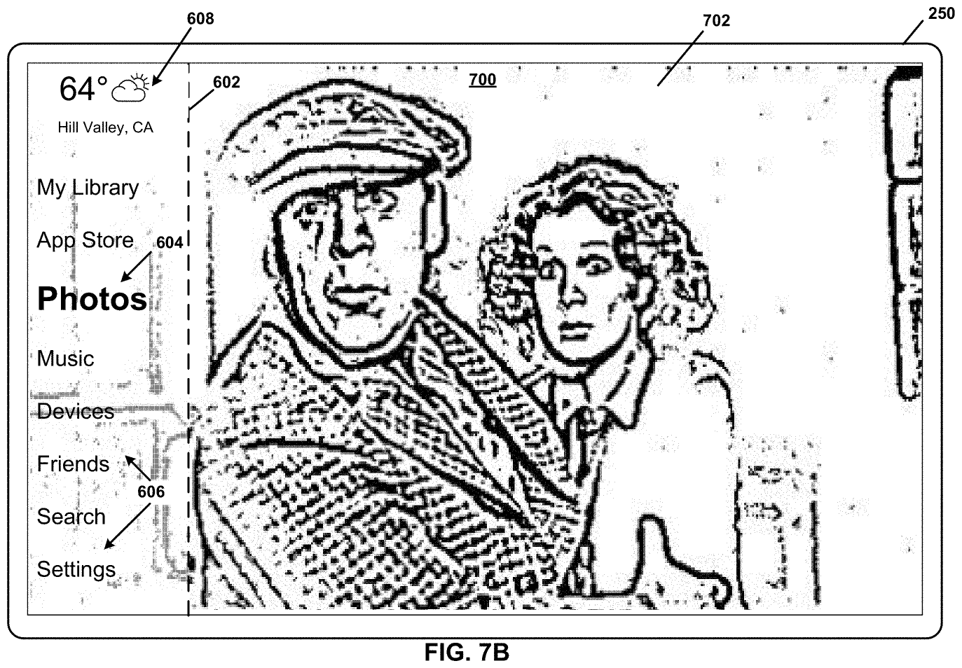

In one example, graphical user interface 230 may be configured to display graphical user interfaces with visual effects that enhance a user's experience browsing content. For example, as illustrated in FIGS. 7A-7B, FIG. 8, FIG. 10, and FIG. 12 graphical user interfaces may be overlaid on top of content a user is viewing in a semi-transparent manner. The level of transparency of an overlaid graphic may vary based on a desired level of interference with content a user is viewing. For example, levels of transparency may be lower towards the edges of a display. Further, graphics processing unit 230 may be configured to make transitions between graphical user interfaces appear “natural” to a user. For example, when transitioning from graphical user interface 500 to graphical user interface 600, pane 504 and pane 514 may appear to move under pane 506, pane 516, and pane 518 in a continuous motion. In one example, a service provider may wish to enhance a user's browsing experience in order to provide advertisements and promote premium content to a user in a manner that a user perceives as less obtrusive.

Display processor 232 may be configured to retrieve and process pixel data for display. For example, display processor 232 may receive pixel data from video decoder 228 and/or graphics processing unit 230 and output data for display. Display processor 232 may be coupled to a display, such as display 250 (not shown in FIG. 1) using a standardized communication protocol (e.g., HDMI, DVI, DisplayPort, component video, composite video, and/or VGA). Display 250 may comprise one of a variety of display devices such as a liquid crystal display (LCD), a plasma display, an organic light emitting diode (OLED) display, or another type of display device capable of presenting video data to a user. Display 250 may include a standard definition television, a high definition television or an ultra-resolution display. Further, display 250 may include an integrated display of a portable computing device (e.g., a mobile phone, a laptop, a personal data assistant (PDA), or a tablet device). As described above, in some examples a portable computing device may operate as an I/O device for a stationary computing device.

As described above, traditional electronic program guides (EPGs) may be less than ideal for enabling a user to select available content. Further, traditional EPGs may be limited in the techniques that a user may use to navigate to a particular item of content. For example, a traditional EPG may limit a user to sorting on air television programming by channel and time and to sorting on demand content by genre or alphabetically. Further, traditional EPGs may not be able to effectively integrate advertising and promote premium content. Computing device 200 may be configured to enable the selection of content by providing one or more of the graphical user interfaces described herein. The graphical user interfaces described herein may be provided to a computing device and/or an I/O device in communication with a computing device. FIGS. 5A-12 are conceptual diagrams illustrating examples of graphical user interfaces that may be generated by a computing device in accordance with one or more techniques of this disclosure. FIG. 4 is a conceptual diagram illustrating example navigational paths to example graphical user interfaces in accordance with one or more techniques of this disclosure. That is, FIG. 4 illustrates examples of command sequences (e.g., sequence of button activations using I/O device 300 or equivalent voice commands or gestures) that may cause a particular graphical user interface to be presented.

In the example illustrated in FIG. 4, a user viewing content in a full screen viewing mode 400 may cause graphical user interface 500 illustrated in FIG. 5A to be presented by activating MyTV button 332 or select button 342. In the example illustrated in FIG. 4, a user viewing content in a full screen viewing mode 400 may cause graphical user interface 900 illustrated in FIG. 9 to be presented by activating What's Hot button 331. In the example illustrated in FIG. 4, a user viewing content in a full screen viewing mode 400 may cause graphical user interface 1200 illustrated in FIG. 12 to be presented by activating guide button 345. Further, a user may navigate to each of graphical user interface 500, graphical user interface 900, graphical user interface 1200, and other graphical user interfaces, i.e., on demand 1300, photos 1400, friends 1500, my library 1600, music 1700, search 1800, app store 1900, devices 2000, and settings 2100, through menu bar navigation. It should be noted that for the sake of brevity graphical user interfaces associated with on demand 1300, photos 1400, friends 1500, my library 1600, music 1700, search 1800, app store 1900, devices 2000, and setting 2100 are not illustrated herein. Graphical user interfaces associated with on demand 1300, photos 1400, friends 1500, my library 1600, music 1700, search 1800, app store 1900, devices 2000, and setting 2100 may incorporate the one or more of the techniques described herein. For example, a graphical user interface associated with on demand 1300 may be similar to graphical user interface 900 described with respect to FIG. 9. Menu bar navigation is described in detail below with respect to FIGS. 7A-7B. Thus, according to the example illustrated in FIG. 4, a computing device is configured to enable a user to select content using multiple navigation techniques.

FIG. 5A is an example of a graphical user interface that may be generated by a computing device to implement one or more techniques of this disclosure. Graphical user interface 500 represents an example of a graphical user interface that may enable a user to select content. As described above, during a typical user viewing session a user may wish to navigate to an event and a user may not know the channel or provider associated with the event. Graphical user interface 500 is an example of a graphical user interface that facilitates efficient selection of content by a user. In addition to enabling a user to select content in an efficient manner, graphical user interface 500 may enable a service provider to increase revenue opportunities by promoting premium content and by providing advertisements to a user. It should be noted that although graphical user interface 500 is described with particular types of distinct panes, such distinctions are for descriptive purposes and a particular item of content may be associated with one or more types of panes (e.g., an item may both be a featured item of premium content and popular item of content). Further, in other embodiments the number of each type of pane may vary. For example, graphical user interface 500 may include multiple advertisement panes and may not include a pane based on social media activity.

In the example illustrated in FIG. 5A, graphical user interface 500 includes time sensitive content pane 502, featured premium content pane 504, playback pane 506, social media content pane 508, recommended content pane 510, featured on demand content pane 512, suggested category of content pane 514, advertisement pane 516, and popular content pane 518. As illustrated in FIG. 5A, each of time sensitive content pane 502, featured premium content pane 504, social media content pane 508, recommended content pane 510, featured on demand content pane 512, suggested category of content pane 514, advertisement pane 516, and popular content pane 518 include images representing items of content. In one example, each of time sensitive content pane 502, featured premium content pane 504, social media content pane 508, recommended content pane 510, featured on demand content pane 512, suggested category of content pane 514, advertisement pane 516, and popular content pane 518 may include animations (e.g., successive images for a particular item of content) and/or videos representing an item of content. In one example, particular items of content provided in each of time sensitive content pane 502, featured premium content pane 504, social media content pane 508, recommended content pane 510, featured on demand content pane 512, suggested category of content pane 514, advertisement pane 516, and popular content pane 518 may be determined based on a likelihood of selection by a user and/or by direct placement.

As described above, while a user is viewing content in a full screen viewing mode, a user may cause graphical user interface 500 to be displayed. Playback pane 506 includes a video window displaying content that was previously presented in a full screen viewing mode. That is, when a user causes graphical user interface 500 to be presented the content the user is viewing is displayed in window 506. In one example, video presented in a full screen viewing mode may appear to shrink to create playback pane 506. The audio corresponding to the video content displayed in playback pane 506 may be presented to the user while graphical user interface 500 is displayed. In this manner, the user can browse for content while content is being presented to the user.

In the example illustrated in FIG. 5A, time sensitive content pane 502 may include content that is live and/or content that is currently airing through an on air television presentation (e.g., first run content). In one example, time sensitive content may be distinguished from content that is not time sensitive based on whether the content can be retrieved by a user in its entirety from a storage device. For example, a movie that is available on an on demand basis through a streaming service and a recorded television show that can be retrieved from a PVR may be considered content that is not time sensitive. As illustrated in FIG. 5A, pane 502 is larger than the other panes and pane 502 includes text 503 identifying content as time sensitive. Each of the pane size, location within graphical user interface 500, and text 503 may enable a user to quickly locate and access time sensitive content using the selection methods described below.

As described above, in a typical scenario a user may know a time sensitive event that he or she wishes to view and that the event is currently airing (e.g., a sporting event, a television show premiere or finale), but may not know the source providing the event. A computing device and/or a service provider may select a particular item of content for time sensitive content pane 502 using one or more techniques. In one example, a particular item of content provided in time sensitive content pane 502 may be selected based on the likelihood of selection by all users of a service. For example, a particular item of content included in time sensitive content pane 502 may be selected based on being a historically popular event, for example, the Super Bowl or the finale of a popular television series. In other examples, a particular item of content selected for time sensitive content pane 502 may be personalized to a subclass of users and/or to individual users. For example, an event involving a local/regional sporting team may be selected for users within a particular region. In one example, a particular item of time sensitive content may be selected based on individual viewing behavior. For example, if a user has watched a particular show, time sensitive content pane 502 may include first runs of the particular show. In one example, a particular item of content included in time sensitive content pane 502 may be selected by direct placement. For example, if a network wishes to feature the broadcast premiere of a new television show, the network may request (e.g., pay for placement) a service provider to include the premiere of the new television show in time sensitive content pane 502.

Featured premium content pane 504 may include content that is available to a user based on a user having a particular set of credentials. For example, content included in featured premium content pane 504 may include content that a user may access upon upgrading to a particular subscription package. In a manner similar to that described above with respect time sensitive content pane 502, a computing device and/or a service provider may select a particular item of content for featured premium content pane 504 using one of more of the likelihood of selection by all users of a service, the likelihood of selection by a subclass or users, the likelihood of selection by a particular user, and/or direct placement. In the example illustrated in FIG. 5A, graphical user interface 500 includes featured on demand content pane 512. In one example, featured on demand content pane 512 may include content that is available to user based on a pay per view basis. In a manner similar to selecting a particular item of content for featured premium content pane 504, content selected for featured on demand content pane 512 may be selected using one or more of the likelihood of selection by all users of a service, the likelihood of selection by a subclass or users, the likelihood of selection by a particular user, and/or direct placement.

As described above, a social media site may provide data (e.g., number of endorsements by users during a given time period) which may be used to determine the popularity of items of content. Social media content pane 508 may include content that has been determined to be popular and/or of interest to a user based on social media data. In one example, content included in social media pane 508 may correspond to content that is time sensitive. In other examples, content included in social media content pane 508 may include upcoming content and content that is available on an on demand basis. In the example illustrated in FIG. 5A, social media content pane 508 includes selectable hyperlinked icons 509, which upon activation may enable a user to access a social media service. In the example illustrated in FIG. 5A, graphical user interface 500 includes popular content pane 518. Popular content pane 518 may include content that has been determined to be popular and/or of interest to a user based on data other than social media data, e.g., actual viewing data based on Nielsen ratings and/or user requests for content. In one example, content included in popular content pane 518 may correspond to content that is time sensitive. In other examples, content included in popular content pane 518 may include upcoming content and content that is available on an on demand basis.

Recommended content pane 510 may include content that been endorsed by friends of a user, where friends of a user may include individuals connected to a user through one or more social networks including proprietary social networks created by a service provider. In the example illustrated in FIG. 5A, recommended content pane 510 includes an item of recommended content and icons 511 identifying the friends of the user that have recommended the content. In the example illustrated in FIG. 5A, suggested category of content pane 514 may provide a user access to content of a particular type. In one example, a category of content may be selected based on user behavior. In other examples, a category of content may be selected for all users of a service. For example, many users of a service may wish to browse only content that is appropriate for children when children are present.

In the example illustrated in FIG. 5A, graphical user interface 500 includes advertisement pane 516. As illustrated in FIG. 5A, advertisement pane 516 includes an image of a product and text describing the product. In other examples, advertisement pane may include an animation (e.g., a Flash animation) and a click-through URL, which upon selection may direct a user to a web page associated with the product. In one example, the content of advertisement pane 516 may be provided by an ad server. The ad server may serve ads based on specific user behavior and/or user demographic information. In some examples, a service provider may sell access to advertisement pane 516 and/or charge for advertisements based on a click-through rate. In one example, upon selection of advertisement pane 516, a video advertisement corresponding to a product or service may be presented in either a full screen mode viewing mode or in a pane overlaid on graphical user interface 500. After presentation of the video advertisement completes, graphical user interface 500 may be presented as illustrated in FIG. 5A. In other examples, selection of advertisement pane 516 may cause other graphical user interfaces related to a product or services to be presented.

In the example illustrated in FIG. 5A, each of featured premium content pane 504, featured on demand content pane 512, and advertisement pane 516 provide a service provider with opportunities to increase revenues. For example, a service provider may charge for placement of a particular item of content within a pane and/or may receive a residual when a particular item of content is selected. While each of time sensitive content pane 502, social media content pane 508, recommended content pane 510, suggested category of content pane 514, and popular content pane 518 may increase revenue for a service provider, each of these panes may primarily be configured to aid a user in navigating to a particular item that a user is likely interested in accessing. That is, a user may cause graphical user interface 500 to be presented (e.g., by activating MyTV button 332) and one of the panes included in graphical user interface 500 may include a particular item of content that a user desired to access (e.g., a popular time sensitive event). Because graphical user interface 500 enables efficient access to content and continues to present content to a user, the placement of featured content and advisements within graphical user interface 500 may not seem obtrusive to a user. That is, if a user has a high level of confidence that graphical user interface 500 will include content that the user is interested in, the user may be more responsive to advertisements provided within graphical user interface 500.

As described above, an I/O device may enable a user to navigate to particular items using directional navigation, (e.g., moving a cursor to an item of content and/or using navigational arrow buttons 341). In the example illustrated in FIG. 5A, a user may select each of the panes using directional navigation. As illustrated in FIG. 5A, playback pane 506 is highlighted and labeled as a selected pane 520. A user may select any of the other panes in graphical user interface 500 through directional navigation (e.g., successive activation of navigational arrow buttons 341). Once a pane is selected, a user may further select a pane (e.g., activation of a select button 342, double click of a mouse button, or a double tap on a touchscreen). An additional selection of an item of content may cause an item of content, a preview of an item of content, a web page, and/or a graphical user interface associated with an item of content to be presented. It should be noted that there may be multiple types of additional selections available, where each type of additional selection is associated with a particular command. For example, an additional selection of time sensitive content pane 502 may include activating select button 342 which may cause a computing device to tune to a channel or access a stream providing the content and present the item of content in a full screen viewing mode or in playback pane 506. Further, an additional selection of time sensitive content pane 502 may include activating information button 343 which may cause an informational pane to appear. An additional selection of featured on demand content pane 512 may cause a graphical user interface which enables a user to purchase access to an item of content to be presented. As described above, with respective to advertisement pane 516, further selection of a pane may cause a web page to be presented to a user.

It should be noted that in some examples, further selection may occur if a pane remains selected for a predetermined amount of time. For example, in the case where a user performs successive activation of navigational arrow buttons 341 to select time sensitive content pane 502, the image in time sensitive content pane 502 may be replaced with a video presentation of the time sensitive content in progress (e.g., content is tuned to), if time sensitive content pane 502 remains selected for a period longer than a predetermined threshold (e.g., two seconds). In this manner, graphical user interface 500 may be configured to present multiple videos simultaneously. Further, in this example, while the video is being presented in time sensitive content pane 502, a user may activate select button 342 to cause content associated with time sensitive content pane 502 to be displayed in a full screen viewing mode.

In one example, further selection of a pane may cause additional content associated with a pane type to be displayed. For example, additional selection of popular content pane 518 may cause a list of popular content to be cycled through (e.g., top ten most popular items of content), where cycling through the list of content causes the image in popular content pane 518 to be updated for each item of content. In one example, a transition between images may appear as though a pane is being flipped over and the new image is on the “back-side” of the first image. In one example, additional selection may occur based on a predetermined time threshold being exceeded. In another example, a user may cause a list to be cycled through. For example, a user may cycle through a list using channel buttons 314. In one example, I/O device 300 may include a dedicated button enabling a user to cycle through items of content for a particular type of pane.

As described above, the types of panes included in graphical user interface 500 may vary. In one example, the types of panes that are included in graphical user interface 500 may vary dynamically based on any and all combinations of consumption, behavior, and environment. In one example, consumption may include content a user has accessed or is accessing. In one example, behavior may include user usage information such as, for example, how fast the user changes channels, how often the user skips commercials, how frequently a user accesses content through a computing device. In one example, environment may include time (e.g., hour, day, month, or year) and location (e.g., home, car, or airport) of a computing device. For example, as illustrated in FIG. 5B graphical user interface may include traffic information pane 522, where traffic information pane 522 is included in graphical user interface 500 based on whether it is likely that a user will be commuting to work in the near future. For example, traffic information pane 522 may be presented on weekdays from the times of 7:00 AM-9:00 AM or during time periods as determined based on monitored user behavior.

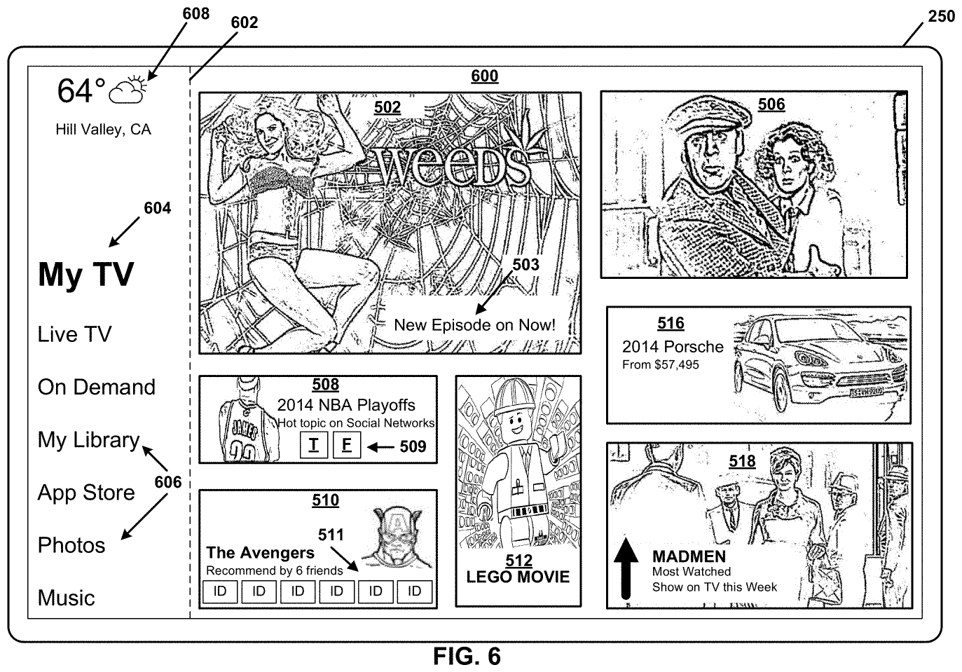

Referring again to FIG. 4, a user may transition between graphical user interface 500 and graphical user interface 600 using right and left navigational buttons. That is, in one example, if one of time sensitive content pane 502, social media content pane 508, or recommended content pane 510 is selected, activation of left arrow navigation button may cause menu bar 602 to appear and featured premium content pane 504 and suggested category of content pane 514 to become hidden. Further, activation of right arrow navigation key when My TV is selected in menu bar 602, as illustrated in FIG. 6, may cause menu bar 602 to disappear and featured premium content pane 504 and suggested category of content pane 514 to appear. As described above, in one example, pane 504 and pane 514 may appear to slide under pane 506, pane 516, and pane 518. Such transitions between graphical user interfaces may increase a user's experience.

As described above, a user may navigate to a graphical user interface through menu bar navigation. FIG. 6 illustrates an example of a graphical user interface presented to a user during menu bar navigation. As illustrated in FIG. 6, graphical user interface 600 includes time sensitive content pane 502, playback pane 506, social media content pane 508, recommended content pane 510, featured on demand content pane 512, advertisement pane 516, and popular content pane 518, described above with respect to FIG. 5A. As further illustrated in FIG. 6, graphical user interface 600 includes menu bar 602, where menu bar 602 includes selected item 604, items available for selection 606, and personalized information 608. Personalized information 608 may include information personalized to a particular user. For example, in addition to including weather information based on a user's location, personalized information may include one or more of a stock ticker, news headlines, sports scores, traffic information, and a user profile icon.

Items included within menu bar 604 may be associated with a category of content (e.g., on demand content) and/or may enable a user to access a graphical user interface (e.g., a settings menu). In one example, a user may change selected item 604 using up/down arrow commands. FIG. 6 illustrates an example graphical user interface that may be presented to a user when My TV item is selected. FIG. 7A illustrates an example graphical user interface that presented when Live TV item is selected. FIG. 7B illustrates an example graphical user interface that presented when Photos item is selected. As illustrated in the graphical user interfaces of FIG. 6 and FIG. 7A and the navigation paths illustrated in FIG. 4, changing the selected item from Live TV item to My TV item causes a full screen presentation of content 702 to be presented in a playback pane 506 and causes time sensitive content pane 502, social media content pane 508, recommended content pane 510, featured on demand content pane 512, advertisement pane 516, and popular content pane 518 to appear. As describe above, activation of a right arrow button while graphical user interface 600 is presented may cause graphical user interface 500 to be presented.

It should be noted that in other cases changing a selected item 604 may or may not cause a full screen presentation of content 702 to be modified. As illustrated in FIG. 7A-7B graphical user interface 700 includes menu bar 602, as described above with respect to FIG. 6 and a full screen presentation of content 702. As illustrated in FIGS. 7A-7B, menu bar 602 may be overlaid on top of content in presented in a full screen viewing mode in a semi-transparent manner. Thus, as illustrated with respect to FIGS. 7A and 7B a full screen presentation of content may continue as a user changes the selected item from Live TV to Photos. The level of transparency of an overlaid graphic may vary in order to achieve a minimal level of interference with content a user is viewing. Further, the level transparency may vary for different portions of menu bar 602 (e.g., less transparency toward left edge of display 250). In this manner, a user can search for content with only minimal interference to a full screen presentation of content. Minimum interference with a full screen presentation of content may increase a user's viewing experience, particularly in the example when multiple users are viewing an item of content.

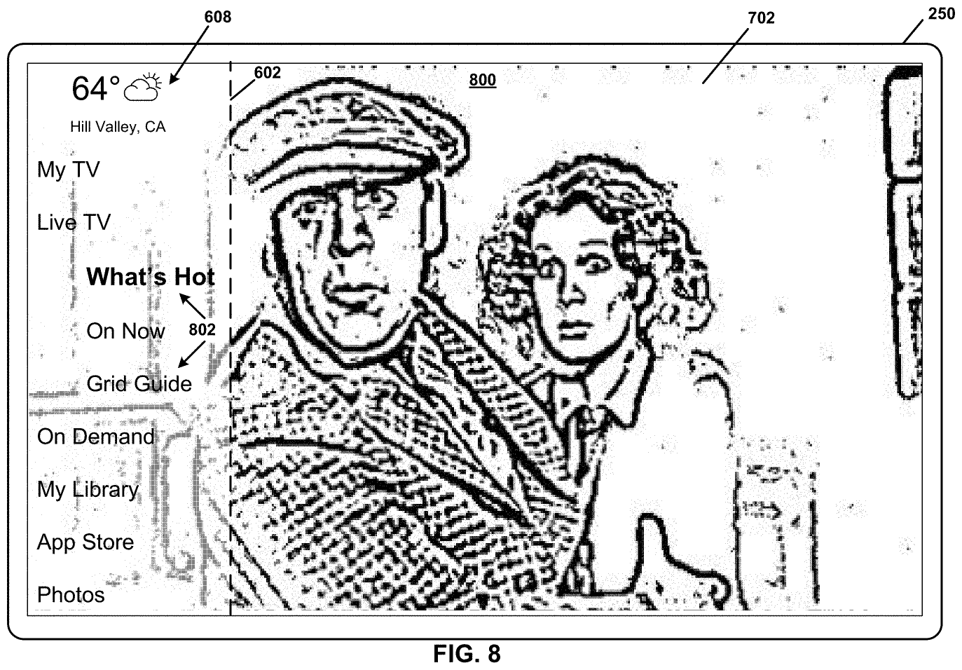

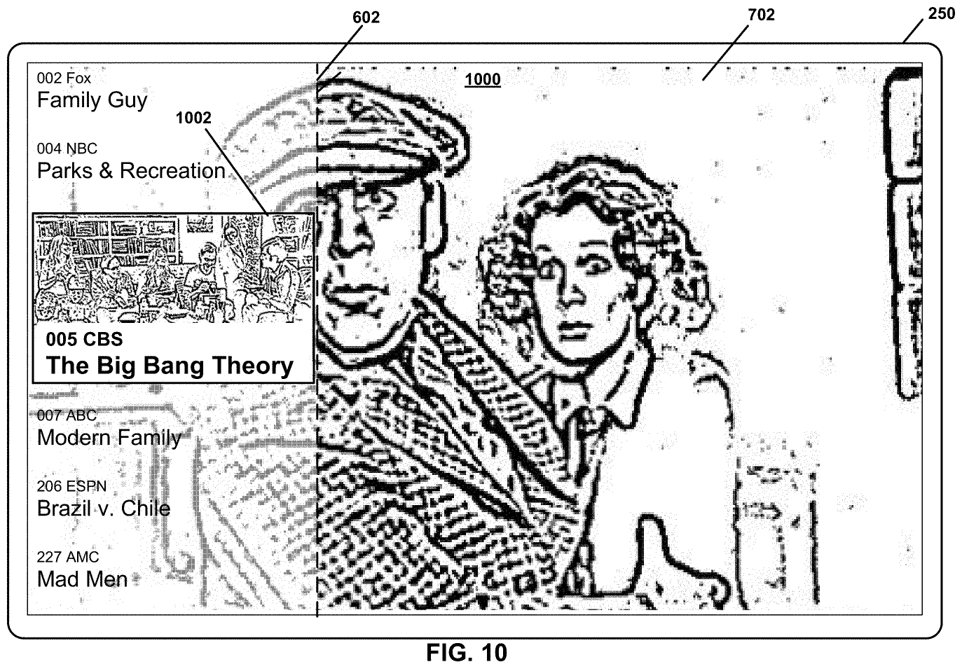

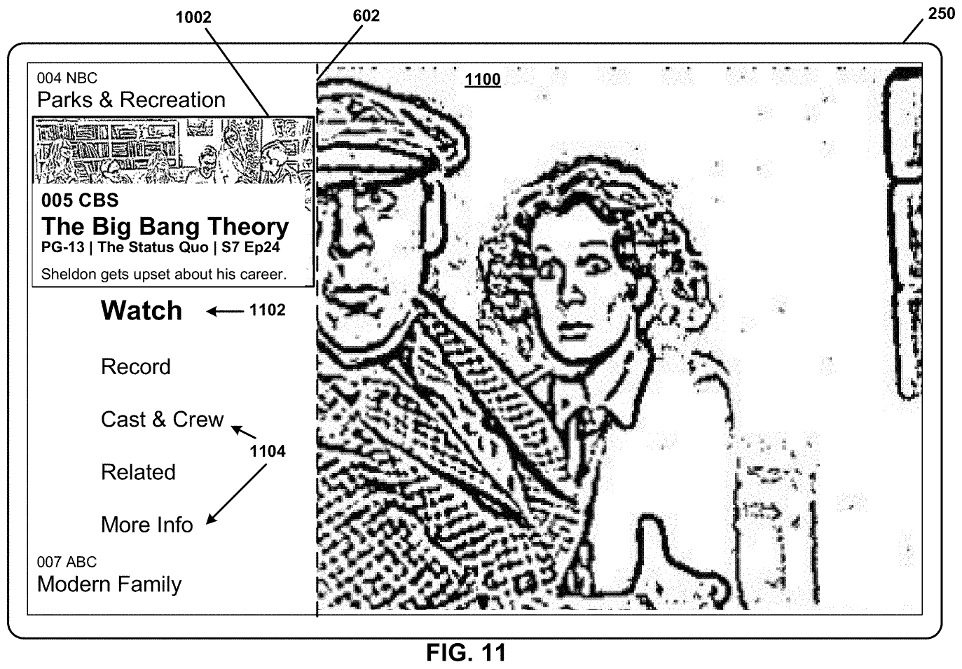

As illustrated in FIG. 4, a user may further select a selected item within menu bar 604 by activating right arrow of navigational arrow buttons 341 or select button 342. In the example illustrated in FIG. 4, an additional selection of Live TV item causes expanded Live TV graphical user interface 800 to be presented. FIG. 8 is a conceptual diagram illustrating an example of an expanded Live TV graphical user interface 800. As illustrated in FIG. 8, graphical user interface 800 includes a full screen presentation of content 702 and menu bar 602, where menu bar 602 includes sub items 802. Sub items 802 includes items specific to a particular item content. For example, On Demand item may include sub items Featured, Movies, and TV shows. Each of sub items may be initially selectable and further selectable in a manner similar to selecting items as described above. That is, selection of a sub item may cause content to be presented, a graphical user interface to be presented, or may cause further sub items to be presented. FIG. 9 is a conceptual diagram illustrating an example of a graphical user interface that is presented when sub item What's Hot is selected. FIG. 10 and FIG. 11 are conceptual diagrams illustrating an example of a graphical user interfaces that are presented when sub item On Now is selected. FIG. 12 is a conceptual diagram illustrating an example of a graphical user interfaces that is presented when sub item Grid Guide is selected.

FIG. 9 is a conceptual diagram illustrating an example of a graphical user interface in accordance with one or more techniques of this disclosure. Graphical user interface 900 may be configured to display items of content based on respective popularity. Graphical user interface 900 includes menu bar 602, as described above, first tier of popular content panes 902a-902b, second tier of popular content panes 904a-904d, and third tier of popular content panes 906a-906g. As illustrated in FIG. 9, the number of panes and size of each pane within a tier varies, which provides a user with a visual indication of relative popularity for each item of content. Further, in the example illustrated in FIG. 9, the first tier of popular content panes 902a-902b are labeled as “ON FIRE,” the second tier of popular content panes 904a-904d are labeled as “Smokin'” and the third tier of popular content panes 906a-906g are labeled as “Smoldering.” These labels or similar labels may also provide a user with a visual indication of relative popularity. In a manner similar to that described above with respect to FIG. 5A, each of the panes included in graphical user interface 900 may include an image associated with an item of content and each of the panes may be available for multiple types of selection. For the sake of brevity, a detailed description of pane selection is not repeated for graphical user interface 900. It should be noted, however, that each panes of content in illustrated in FIG. 900 may be updated as popularity information is updated. For example, a pane may move from the second tier to the first tier, if a significant increase in popularity occurs.

Although described above with respect to graphical user interface 900, in other examples, What's Hot item may be associated with other example graphical user interfaces that display items of content based on relative popular. In one example, What's Hot item may be associated with graphical user interfaces described in commonly-assigned, co-pending U.S. patent application Ser. No. 14/260,677, which is incorporated by reference in its entirety.

FIG. 10 and FIG. 11 are conceptual diagrams illustrating examples of graphical user interfaces in accordance with one or more techniques of this disclosure. As illustrated in FIG. 10, graphical user interface 1000 includes a full screen presentation of content 702 and menu bar 602, where menu bar 602 includes an image associated with a selected item of content 1002. A user may change a selected item of content and thus cause image 1002 to be updated using up/down arrow commands as described above with respect to menu bar navigation. In one example, in a manner similar to that described above with respect to FIG. 5A, if a pane remains selected for a predetermined amount of time (e.g., three seconds) the image 1002 may be replaced with a video presentation of the content. For example, if the content is currently being provided by a television service provider, the content may be displayed in progress. In this manner, graphical user interface 1000 may be configured to present multiple videos simultaneously.

In one example, a user may further select a selected item of content by activating select button 342 or right directional arrow (e.g., while an image is displayed and/or while a video is being presented). Graphical user interface 1100 illustrates an example of a graphical user interface that may be presented when an item of content is further selected. As illustrated in FIG. 11, graphical user interface 1100 includes a full screen presentation of content 702 and menu bar 602, where menu bar 602 includes a selected sub item 1102 and sub items available for selection 1104 associated with a selected item of content. Each of sub items Watch, Record, Cast & Crew, Related, and More Info, may be further selected by user and may cause content to be presented in a full screen viewing mode (i.e., Watch) or a corresponding graphical user interface to be presented.

FIG. 12 is a conceptual diagram illustrating an example of a graphical user interface in accordance with one or more techniques of this disclosure. As illustrated in FIG. 12, graphical user interface 1200 includes a listing of television programs arranged in a grid manner based on a television networks and time slots. In the example illustrated in FIG. 12, the grid guide is overlaid on a full screen presentation of content in a semi-transparent manner. Such a presentation of graphical user interface 1200 may minimize the level of interference with a full screen presentation of content. Further, it should be noted that since computing device 200 may provide a user with alternative and possibly more efficient navigational techniques (i.e., graphic user interface 500 and graphical user interface 700) than grid guide navigation, presentation of graphical user interface 1200 may be based on user preferences. That is, in one example, a user may set a transparency level for graphical user interface presentation and/or a font size. For example, a user that primarily uses graphical user interface 1200 to surf for content while viewing content may wish to have a high level of transparency, whereas a user that primarily uses graphical user interface to search for a known event may wish to have a low level of transparency and may wish that as many listing as possible are displayed simultaneously, i.e., small font size.

In the example illustrated in FIG. 12, graphical user interface 1200 includes current time indicator 1202 and an information panel 1204 corresponding to a selected item of content. Current time indicator 1202 provides a user with a visual representation of the current time. In the example illustrated in FIG. 12, a selected item of content may appear highlighted within the grid (i.e., Thor: Dark World). In the example illustrated in FIG. 12, information panel 1204 includes content description 1206, content progress indicator 1208, and image represented content 1210. Each of content description 1206, content progress indicator 1208, and image represented content 1210 may provide information to a user that will assist a user in determining whether to further select an item of content. In one example, in a manner similar to that described above with respect to FIG. 5A and FIG. 10, if an item within the grid remains selected for a predetermined amount of time (e.g., three seconds) the image 1210 may be replaced with a video presentation of the content. For example, if the content is currently being provided by a television service provider, the content may be displayed in progress. Further, if the item of content is available at a future time, image 1210 may be replaced with a video preview. In this manner, graphical user interface 1200 may be configured to present multiple videos simultaneously.

It should be noted that a computing device may display any and all combinations of the graphical user interfaces illustrated in FIGS. 5A-12 and the example descriptions of how graphical user interfaces may be presented to a user are for illustrative purposes. For example, a computing device may be configured to present a subset of the graphical user interfaces described herein using navigation paths other than the example navigation paths described with respect to FIG. 4. In this manner, computing device 200 represents an example of a device configured enable selection of content using multiple techniques.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. (canceled)

2. A device comprising:
at least one processor; and
a memory connected to the processor;
wherein the memory stores a series of instructions that, when executed by the processor, cause the processor to:
cause display of a first media pane in a first region on a display;
cause display of a second media pane in a second region on the display, the first region distinct from the second region;
receive an input to translate the first media pane; and
cause the first media pane to translate from the first region on the display to the second region on the display, wherein the translation at least partially obscures the first media pane with the second media pane.

3. The device according to claim 2, wherein the display and the device are distinct and different components.

4. The device according to claim 2, further comprising a communication interface, wherein the instructions further cause the processor to communicate with a second device using the communication interface, and further wherein the input to translate the first media pane is received from the second device, the second device distinct from the device.

5. The device according to claim 2, wherein the instructions further cause the processor to cause display of a menu bar in response to receiving the input to translate the first media pane.

6. The device according to claim 5, wherein the instructions further cause the processor to:
receive a second input to remove display of the menu bar; and
cause the first media pane to translate from the second region on the display to the first region on the display.

7. The device according to claim 2, wherein the instructions further cause the processor to cause a change in transparency of the second media pane.

8. The device according to claim 2, wherein the device includes the display and the input is a touch input.

9. A method comprising:
causing display of a first media pane in a first region on a display;
causing display of a second media pane in a second region on the display, the first region distinct from the second region;
receiving an input to translate the first media pane; and
causing the first media pane to translate from the first region on the display to the second region on the display, wherein the translation at least partially obscures the first media pane with the second media pane.

10. The method of claim 9, further comprising causing display of the first media pane by sending commands from a first device to a second device.

11. The method of claim 9, wherein a first device causes display of the first media pane, the method further comprising receiving the input from a second device that is distinct from the first device.

12. The method of claim 9, further comprising causing display of a menu bar in response to receiving the input to translate the first media pane.

13. The method of claim 12, further comprising:
receiving a second input to remove display of the menu bar; and
causing the first media pane to translate from the second region on the display to the first region on the display.

14. The method of claim 9, further comprising causing a change in transparency of the second media pane.

15. The method of claim 9, wherein a first device that includes a display, causes display of the first media pane, the method further comprising:
receiving a touch input on the display; and
causing the first media pane to translate in response to the touch input.

16. A non-transitory computer readable medium comprising instructions, that when executed by a processing device, cause the processing device to:
cause display of a first media pane in a first region on a display;
cause display of a second media pane in a second region on the display, the first region distinct from the second region;
receive an input to translate the first media pane; and
cause the first media pane to translate from the first region on the display to the second region on the display, wherein the translation at least partially obscures the first media pane with the second media pane.

17. The non-transitory computer readable medium of claim 16, wherein the input to translate the first media pane is a touch input on the display.

18. The non-transitory computer readable medium of claim 16, wherein the display is part of a first device and the input to translate the first media pane is received from a second device that is distinct from the first device.

19. The non-transitory computer readable medium of claim 16, wherein the instructions further cause the processor to cause display of a menu bar in response to receiving the input to translate the first media pane.

20. The non-transitory computer readable medium of claim 19, wherein the instructions further cause the processor to:
receive a second input to remove display of the menu bar; and
cause the first media pane to translate from the second region on the display to the first region on the display.

21. The non-transitory computer readable medium of claim 16, wherein the instructions further cause the processor to cause a change in transparency of the second media pane.
